(19) United States
(12) Patent Application Publication
(10) Pub. No.: US 2006/0110137 A1
(43) Pub. Date: May 25, 2006

(54) Video and audio data transmitting apparatus, and video and audio data transmitting method

(75) Inventors: Kenjiro Tsuda, Osaka (JP); Katsuo Saigo, Kobe-shi (JP); Hideyuki Ohgose, Osaka (JP); Hiroaki Shimazaki, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/240,369

(22) Filed: Oct. 3, 2005

(30) Foreign Application Priority Data
Nov. 25, 2004 (JP) 2004-341001

(51) Int. Cl. H04N 7/16; H04N 5/91

(52) U.S. Cl. 386/123; 725/5

(57) ABSTRACT

An object of the present invention is to create a status where the copyright protection and the improvement in userfriendliness can be concurrently realized. This can be realized by enabling a user to select the way how the digital video and audio data is made unavailable for playback. More specifically, whether the data is to be made unavailable for playback in an unrecoverable manner or in a recoverable manner may be determined depending on the deterioration level in data rate that is made at the time when the recorded digital video and audio data with which a copy-once signal is multiplexed is transmitted to another recording medium.

The video and audio data transmitting apparatus that transmits the video and audio data recorded on the first recording medium to the second recording medium includes: a conversion processing unit 103 that converts the format of the video and audio data recorded on the first recording medium; a conversion detail judgment unit 101 that judges the conversion details concerning the video and audio data; and a playback disabling unit 106 that makes the video and audio data recorded on the first recording medium unavailable for playback in a recoverable manner based on the judgment made by the conversion detail judgment unit 101. The video and audio data transmitting apparatus makes it possible to solve a conventional problem.

### BACKGROUND OF THE INVENTION

(1) Field of the Invention

The present invention relates to (i) a video and audio data transmitting apparatus that transmits digital video and audio data and the like from a first recording medium to a second recording medium and (ii) a video and audio data transmitting method.

(2) Description of the Related Art

A digital video recorder that converts an analog video and audio signal distributed in analog television broadcasting into a digital video and audio signal by performing compression coding of the analog video and audio signal and that records the resulting digital video and audio signal on a hard disc (HDD) or an optical disc (DVD-RAM or the like) has recently become popular. Further, a digital video recorder that can directly records such digital video and audio data is becoming popular since digital video and audio data can be distributed via satellite broadcasting (BS and CS), terrestrial wave broadcasting, cable television, the Internet and the like. Since digital video and audio data has an advantageous feature that they can be copied and transmitted without any deterioration in its picture and sound quality, research and development of a system and a technique concerning copyright protection of such digital video and audio data has been carried out.

Especially, a system called “copy-once” or “copy-one generation” (described as “copy-once” hereinafter) has been introduced in digital television broadcasting. Copy-once system is a system for multiplexing digital video and audio data with a copy control signal that allows to record the digital data only once at the time of receiving the digital data through broadcasting.

This system enables a user to enjoy time-shift viewing in a status where digital video and audio data is recorded only on a single recording medium taking into consideration copyright protection. Time-shift viewing allows a user to view television broadcasting irrespective of the time zone during which the television broadcasting is received.

Also, in the case where a digital video recorder with an HDD receives and records digital video and audio data with a copy-once signal that is distributed through digital broadcasting or the like, the copy-once signal is changed to a copy control signal that disable copying at the time when the digital video and audio data is recorded on the HDD. This prohibits copying and holding the same data on a plural recording media. The system in this case enables performing only move processing for moving such data to an external recording medium (DVD-RAM or the like) such as a Content Protection for Recordable Media (CPRM) that is suitable for copyright protection, in other words, move processing for moving digital video and audio data to the second recording medium (memory card) after the original data recorded on the first recording medium (HDD) is deleted or the original data is completely made unavailable for playback.

Patent Document 1 titled “Recording apparatus, playback apparatus and sending apparatus of digital information” (Patent literature 1: Japanese Laid-Open Patent Application No. 2002-251819 Publication.) discloses the invention that can protect a copyright in a safer manner preventing unnecessary copied data from being generated by managing, using a clock, time during which the received and recorded digital video and audio data with a copy-once signal can be moved or temporally copied for viewing.

On the other hand, when focusing on the copyright protection too much, it becomes difficult for a user who views video and audio data (simply called user hereinafter) to handle the video and audio data.

More specifically, in the case of transmitting digital video and audio data with a copy-once signal recorded on an HDD to an external recording medium such as an optical disc, it is impossible to transfer the whole video and audio data at the time of trying to transmit the video and audio data to the optical disc. This is because there is a big difference in recording capacity between the HDD and the optical disc, and therefore, such an external recording medium with a limited recording capacity has a restriction on recordable time. On the other hand, the video and audio data in the HDD is deleted or the data is made unavailable for playback at the time of being transmitted because the data is copy-once data. This results in disabling the complete recovery of the original data.

Also, in the case where the whole video and audio data (contents) recorded on an HDD needs to be transmitted to an optical disc with a small recording capacity, the data rate of the digital video and audio data is lowered through compression coding and then the digital video and audio data is to be recorded on the external recording medium. However, the original digital video and audio data is deleted or the data is made unavailable for playback after it is transmitted like in the above-described case. Therefore, it becomes impossible to view the digital video and audio data at the same level of picture and sound quality as that of the original digital video and audio data.

In order to solve the above-described problem, the technique including the following has been proposed: transmitting video and audio data with a copy-once signal; disabling the playback of the original data as long as the data related to the original data is present in the transmit-destination medium instead of completely deleting the original video and audio data; and recovering the original data at the time when the data that is present in the transmit-destination medium is deleted or the data is made unavailable for playback.

However, from the viewpoint of the copyright protection, the following status is not desired even though the original data has been made unavailable for playback: status where video and audio data that is copied with almost no deterioration in its picture or sound quality compared to the original data is present on another recording medium.

On the other hand, from the viewpoint of userfriendliness, the following status is very troublesome and lacks userfriendliness: status where a user must judge whether or not the original data should be made unavailable for playback in a recoverable manner based on the conversion details or the like in addition to performing a complex operation of determining and specifying such conversion details.

The present invention is conceived considering the above-described problem. An object of the present invention is to provide a video and audio data transmitting apparatus or the like that can automatically judge whether or not the video and audio data recorded on the first recording medium should be recovered at the time of transmitting the video and audio data.

### SUMMARY OF THE INVENTION

In order to solve the above-described problem, the video and audio data transmitting apparatus of the present invention transmits video and audio data recorded on a first recording medium to a second recording medium, the apparatus including: a conversion processing unit that converts a format of video and audio data recorded on a first recording medium; a conversion detail judgment unit that judges details of the conversion which is performed by the conversion processing unit; and a playback disabling unit that disables, in a recoverable manner, playback of the video and audio data recorded on the first recording medium based on the judgment made by the conversion detail judgment unit.

In this way, whether the data should be made unavailable for playback in a recoverable manner or not is automatically judged. Therefore, it becomes possible to easily realize the status where a copyright is protected with respect to the owner of a copyright and userfriendliness is improved.

Also, in a first aspect of the present invention, the video and audio data transmitting apparatus may further include: a completion signal notification unit that outputs a conversion completion signal to the playback disabling unit at the time when the conversion processing unit completes conversion processing, in the apparatus, the playback disabling unit performs disabling processing after receiving the conversion completion signal.

In this way, it becomes possible to make the original data unavailable for playback at the same time when the conversion is completed. Therefore, it becomes possible to surely realize the status where the data contents cannot be viewed simultaneously with different recording media, in other words, the status where the copyright is protected.

In the first aspect of the present invention, the video and audio data transmitting apparatus may further include: a payment status judgment unit that judges a fee payment status, the fee being charged for data transmission, in the apparatus, the playback disabling unit disables, in a recoverable manner, playback of the video and audio data recorded on the first recording medium based on a combination of the following two judgments: the judgment made by the payment status judgment unit and the judgment made by the conversion detail judgment unit.

From the viewpoint of a user, this enables the user to view the video and audio data transmitted to another media enjoying high picture and sound quality, in other words, this enables improving userfriendliness. On the other hand, from the viewpoint of the owner of a copyright who provides the video and audio data, this enables the owner of the copyright to protect the copyright effectively by ensuring a profit by charging for the use fee.

Note that the present invention can be realized not only as a video and audio data transmitting apparatus like this but also as an integrated circuit with characteristic functional units of the video and audio data transmitting apparatus, and thus it becomes possible to obtain a similar effect. Also, the present invention can be realized as a video and audio data transmitting method including steps corresponding to the functions of the above-described respective functional units or a program causing a computer to execute the method, and thus it becomes possible to obtain a similar effect.

With the video and audio data transmitting apparatus and the video and audio data transmitting method of the present invention, it becomes possible to easily realize the status where the following can be concurrently realized: (i) keep preventing the video and audio data from concurrently played back by means of plural recording media, resulting in protecting the copyright; and (ii) concurrently enabling viewing of the data transmitted to the second recording medium at a lower quality and viewing the data held on the first recording medium at an original high quality, resulting in improving userfriendliness.

Also, this makes it possible to easily realize the status where a copyright can be protected by preventing the video and audio data having an equal quality from being held on plural recording media.

### FURTHER INFORMATION ABOUT TECHNICAL BACKGROUND TO THIS APPLICATION

The disclosure of Japanese Patent Application No. 2004-341001 filed on Nov. 30th, 2004 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIGS. 1A and 1B are diagrams for illustrating a concept of normal move processing, and show the before-moving processing status and the after-moving processing status respectively;

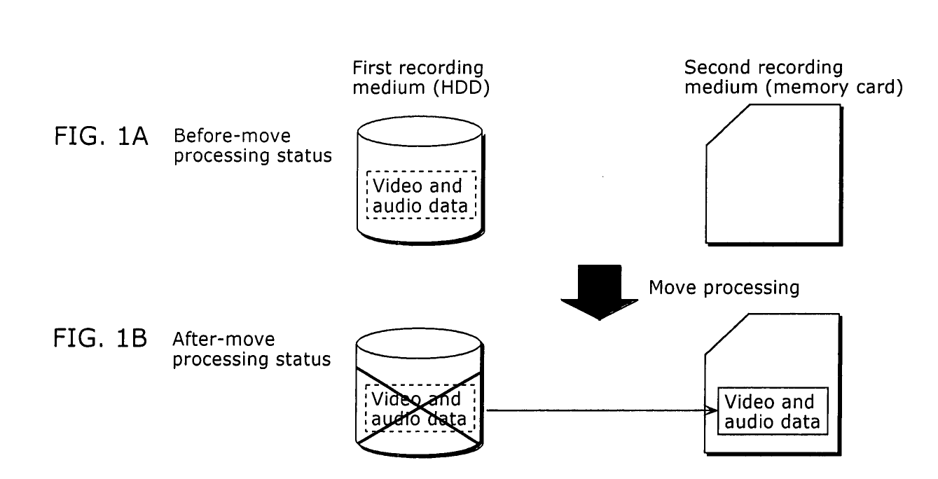

FIG. 2 is a block diagram showing the functional units of a first embodiment of the present invention;

FIG. 3 is a block diagram showing the functional configuration of the conversion processing unit of the first embodiment;

FIG. 4 is a flow chart showing the processing operation of the first embodiment;

FIG. 5 is a diagram conceptualizing a table used for the judgment of details of the conversion;

FIGS. 6A to 6C are diagrams conceptualizing the exclusive use statuses before and after data is transmitted in the first embodiment, and show the before-transmission status, the after-transmission status and after-recovery status respectively;

FIG. 7 is a block diagram showing the respective functions of the video and audio data transmitting apparatus concerning a second embodiment of the present invention;

FIG. 8 is a diagram conceptualizing the details of the charging information held in the charging information holding unit;

FIG. 9 is a flow chart showing the processing operation concerning the second embodiment;

FIG. 10 is a diagram showing an image example displayed on an operation display screen;

FIG. 11 is a block diagram showing the additional functions of the video and audio data transmitting apparatus; and

FIG. 12 is a flow chart showing the processing status of the additional functions.

### DESCRIPTION OF THE PREFERRED EMBODIMENT(S)

### First Embodiment

A first embodiment of the present invention will be described with reference to figures below.

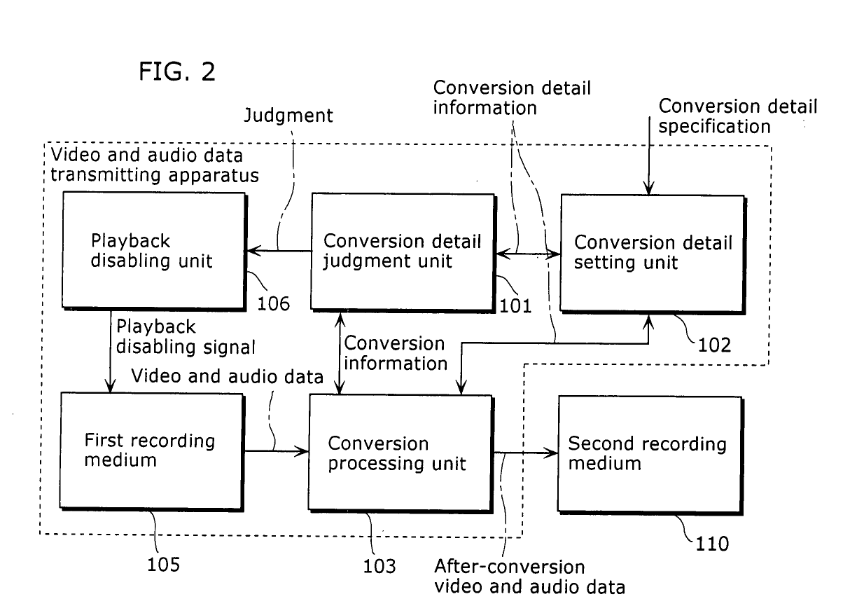

FIG. 2 is a block diagram showing the functional units of a video and audio data transmitting apparatus concerning a first embodiment of the present invention.

The video and audio data transmitting apparatus shown in the figure can convert the conversion details concerning the video and audio data to be recorded on the first recording medium 105 and record the data on the second recording medium 110. The video and audio data transmitting apparatus includes: a playback disabling unit 106; a conversion detail judgment unit 101; a conversion detail setting unit 102; a conversion processing unit 103; and a first recording medium 105.

The first recording medium 105 is, for example, a hard disc drive (HDD) or the like on which digital video and audio data distributed through digital television broadcasting is recorded. Also, analog video and audio data distributed through analog television broadcasting and converted to digital video and audio data by performing compression coding of the analog video and audio data is recorded on such a hard disc.

Like in the case of the above-described first recording medium 105, the second recording medium 110 is a recording medium on which video and audio data is recorded. The second recording medium 110 is a portable optical disc such as a recordable DVD-RAM or a portable small memory card such as an SD card.

The playback disabling unit 106 is for performing processing for making video and audio data recorded on the first recording medium 105 unavailable for playback in a completely recoverable manner under a predetermined condition based on the judgment made by the later-described conversion detail judgment unit 101. Note that this playback disabling unit 106 can make the video and audio data unavailable for playback in an unrecoverable manner by deleting a part of or all of the video and audio data depending on the judgment made by the conversion detail judgment unit 101, the deletion including encryption with a break key hereinafter. In other words, the playback disabling unit 106 selects whether the data should be recoverable or unrecoverable based on the judgment made by the later-described conversion detail judgment unit 101.

Here, playback disabling means that performs processing for deleting or breaking the video and audio data so as to realize a status where the contents cannot be recognized based on the after-processing video and audio data. More specifically, the status includes not only the status where the whole contents cannot be viewed but also the status where parts of the content can be fragmentary viewed although it cannot be completely viewed.

Also, recovery means not overwriting the original data with the same data that is present elsewhere but recovering the original video and audio data with an equal or substantially equal quality (format) by performing any processing (for example, decryption based on a key) on the remaining data.

The conversion detail judgment unit 101 obtains the conversion details at the time when the video and audio data recorded on the first recording medium 105 is recorded on the second recording medium 110, judges whether or not the obtained conversion details are included in a predetermined range, and provides the result to the playback disabling unit 106. Also, as for conversion details, conversion details that are set by the conversion detail setting unit 102 may be obtained, or conversion details may be obtained based on the corresponding header information of video and audio data or the corresponding information amount of the whole data that are recorded on the first recording medium 105 and the second recording medium 110 respectively.

Here, conversion details include the following: a format of video data or sound data obtained through demultiplexing the multiplexed video and audio data; a data compression status and format; a format as the multiplexed video and audio data. In other words, conversion details are used for indicating the difference conversion details to be made between the data recorded on the first recording medium 105 and the corresponding data to be recorded on the second recording medium 110.

The conversion detail setting unit 102 sets the conversion details recorded on the first recording medium 105. As for these conversion details, a user can set them based on a predetermined menu. Also, the setting method by a user may be one of the following two methods: a relative setting method, for example, setting the compression coding rate of the data recorded on the second recording medium 110 at the one-half of that of the original data; and an absolute setting method, for example, setting the size or format of the video and audio data that should be recorded on the second recording medium 110. Also, conversion details may be automatically set based on the result made by the comparison between the data amount of the video and audio data recorded on the first recording medium. 105 and the amount of remaining recording capacity of the second recording medium. Further, conversion details may be set based on the information concerning the conversion details that are allowable for the data to be multiplexed with or attached to the video and audio data.

The conversion processing unit 103 obtains the video and audio data recorded on the first recording medium 105, converts the details concerning the data, and outputs the format-converted data to the second recording medium. Also, the format converted here is set according to the conversion details that are set by the conversion detail setting unit 102.

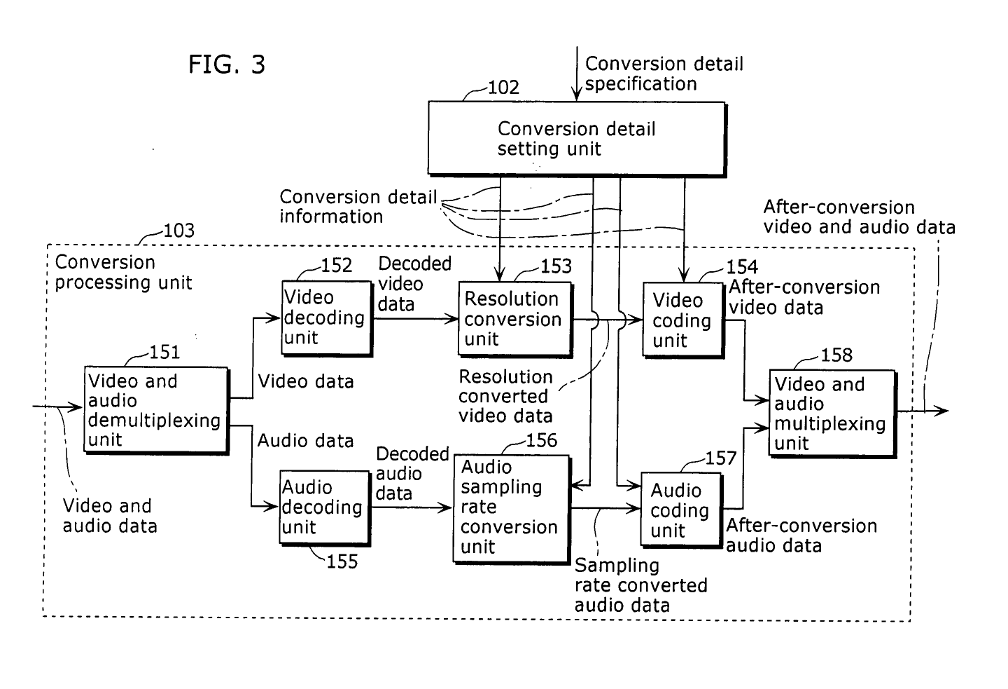

FIG. 3 is a block diagram showing the functional configuration of the conversion processing unit 103 in detail.

As shown in the figure, the conversion processing unit 103 concerning this embodiment can convert the conversion details concerning the video data and the audio data that are obtained through demultiplexing the multiplexed video and audio data. The conversion processing unit 103 includes: a video and audio demultiplexing unit 151; a video decoding unit 152; a resolution conversion unit 153; a video coding unit 154; an audio decoding unit 155; an audio sampling rate conversion unit 156; an audio coding unit 157; and a video and audio multiplexding unit 158.

The video and audio demultiplexing unit 151 demultiplexes the multiplexed video and audio data to obtain the video data and the audio data separately.

The video decoding unit 152 and the audio decoding unit 155 are for decoding the video and audio data multiplexed through compression coding so that the video data and the audio data respectively decoded have an easily convertible format.

The resolution conversion unit 153 converts the resolution of the video data.

The audio sampling rate conversion unit 156 converts the sampling rate of the audio data.

The video coding unit 154 and the audio coding unit 157 perform compression coding of the respective data so that the respective data have a predetermined format.

The video and audio multiplexing unit 158 multiplexes the video data and the audio data that are obtained through demultiplexing so as to multiplex the respective data into video and audio data that can be viewed.

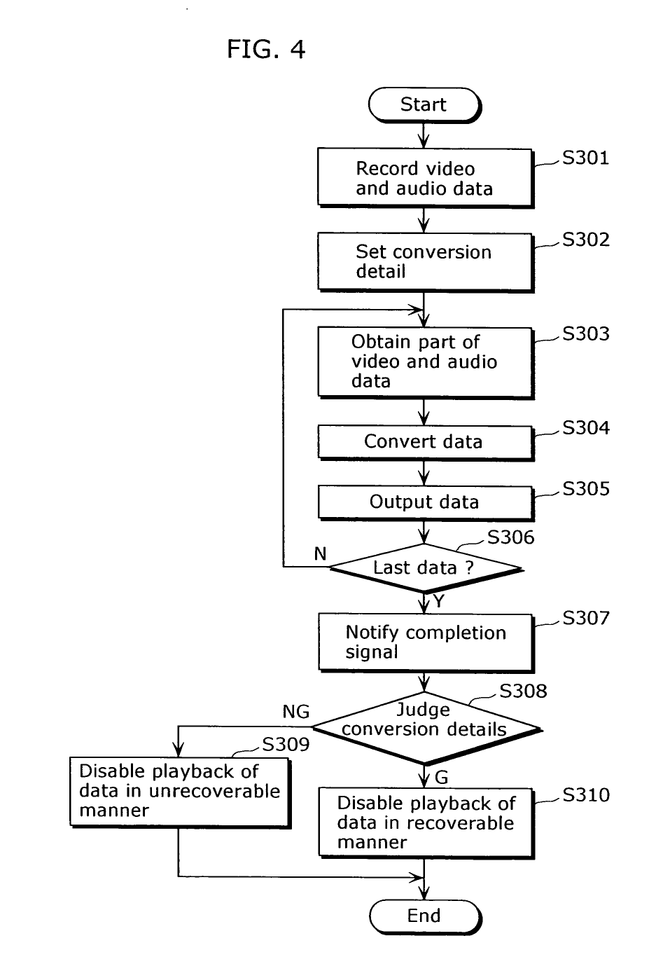

Next, the operation in this embodiment will be described with reference to FIG. 4.

FIG. 4 is a flow chart showing the processing operation of the video and audio data transmitting apparatus concerning this embodiment.

First, video and audio data is received from a known communication mean through a tuner and recorded on the first recording medium 105 (S301).

The video and audio data recorded on this first recording medium 105 is recorded after being encrypted according to the copy control signal multiplexed with the data, and therefore, the copyright can be protected.

A copy control signal shows one of the following: copy-free (Be free to copy.); copy-once (Copying is allowed only once.); copy-no-more (Copying is not allowed.); or the like.

In the example case of this embodiment, video and audio data on which a copy control signal indicating “copy-once” is multiplexed is broadcast and distributed, and then the video and audio data with a copy-once signal is recorded on a first recording medium 105 that is an HDD or the like. Accompanied by the recording processing, the copy control signal indicating “copy-once” is changed to the copy control signal indicating “copy-no-more”, and the changed copy control signal is to be multiplexed with the video and audio data.

Next, the conversion detail setting unit 102 sets conversion details (S302). A user may arbitrarily set these conversion details as described earlier. Also, the conversion detail setting unit 102 may automatically set conversion details based on various conditions.

Next, the conversion detail setting unit 102 obtains a part of the video and audio data to be transmitted from the first recording medium 105 (S303). After that, the conversion processing unit 103 converts the conversion details concerning the data obtained according to the conversion details that have been set by the conversion detail setting unit 102 (S304).

The conversion processing executed by the conversion processing unit 103 is basically for deteriorating video and sound quality, in other words, for lowering the data rate. An example processing having the following steps (1) to (7) will be described below. Also, one of or a combination of the steps of the processing may be executed. These steps of the processing are:

(1) lowering the resolution of video data to compress the data size;

(2) reducing the frame rate of video data;

(3) reducing the compression coding rate of video data, and performing compression coding of the video data again;

(4) changing the compression coding format of video data, and performing compression coding of the video data again;

(5) lowering the sampling frequency and the number of sampling bits of audio data;

(6) reducing the compression coding rate of audio data, and performing compression coding of the audio data again; and

(7) changing the compression coding format of audio data, and performing compression coding of the audio data again.

Further, the conversion processing will be described in more detail below. The multiplexed video and audio data is demultiplexed by the video and audio demultiplexing unit 151.

After that, the video data is decoded by the video decoding unit 152, moved to the resolution conversion unit 153 and then to the video coding unit 154, and inputted to the video and audio multiplexing unit 158 as conversion video data.

The resolution conversion unit 153 executes the conversion processing step (1) among the above-described conversion processing steps based on the conversion details that have been set by the conversion detail setting unit 102. Likewise, the video coding unit 154 executes the conversion processing steps (2) to (4) among the above-described conversion processing step. Note that it is possible to have a frame rate reducing unit executing the step (2).

Meanwhile, the audio data is decoded by the video and audio decoding unit 155, moved to the audio sampling rate conversion unit 156 and then moved to the audio coding unit 157, and inputted to the video and audio multiplexing unit 158 as converted audio data.

The audio sampling rate conversion unit 156 executes the conversion processing step (5) among the above-described conversion processing steps based on the conversion details that have been set by the conversion detail setting unit 102. Likewise, the audio coding unit 157 executes the conversion processing steps (6) and (7) among the above-described conversion processing steps.

In this way, the converted video and audio data is outputted (S305), and judgment as to whether the outputted video and audio data is last or not is made (S306).

At the time when the conversion processing is completed (S306:Y), the completion signal notification unit outputs a completion signal to the playback disabling unit 106 (S307). In this way, the processing of the after-transmitted original data is executed after the completion of the conversion processing is surely confirmed. This makes it possible to surely protect the copyright.

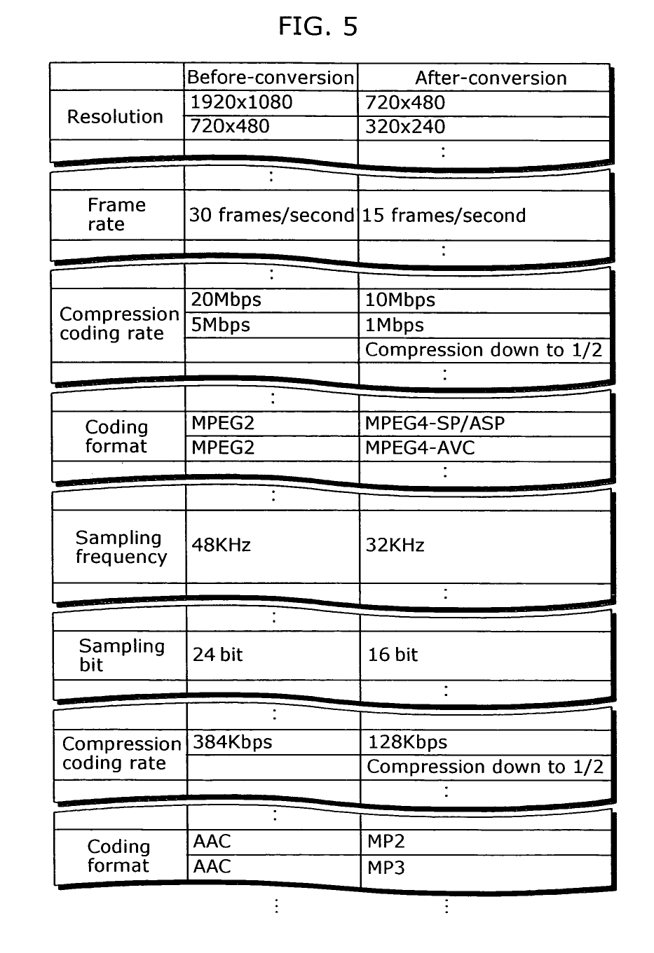

Next, the conversion detail judgment unit 101 judges whether the picture and sound quality of the after-conversion video and audio data has deteriorated down to a predetermined level using a table like FIG. 5 or the like. The judgment is made based on the conversion details that have been set by the conversion detail setting unit 102 or the comparison result of the video and audio data recorded on the first recording medium 105 and the video and audio data recorded on the second recording medium (S308). In other words, the conversion detail judgment unit 101 judges the deterioration level in the quality of video and audio to be viewed.

After that, in the case where the conversion detail judgment unit 101 judges that the picture and sound quality does not deteriorate down to the predetermined level (S308:G), the playback disabling unit 106 disables, in an unrecoverable manner, the playback of the video and audio data recorded on the first recording medium 105 (S309). An example for this case is the case where a value indicating an after-conversion status is larger than the value indicating the corresponding before-conversion status in a table shown as FIG. 5.

On the other hand, in the case where the conversion detail judgment unit 101 judges that the picture and sound quality deteriorates down to a predetermined level or below (S308:NG), the video and audio data recorded on the first recording medium 105 is made unavailable for playback in a recoverable manner (S310). An example for this case is the case where the value indicating an after-conversion status is smaller than the value indicating the corresponding before-conversion status in the table shown as FIG. 5.

Note that a copy control signal is multiplexed with the data at the time when the data is transmitted to the second recording medium. In this embodiment, a copy control signal indicating “copy-no-more” is multiplexed with the data so as to prohibit copying the data held on the second recording medium.

This is the completion of the transmission processing.

Note that the video and audio data transmitting apparatus concerning the present invention causes the conversion detail judgment unit 101 and the playback disabling unit 106 to perform the above-described processing so that the copyright is protected in the case where the copy control signal of the video and audio data recorded on the first recording medium 105 indicates “copy-no-more”.

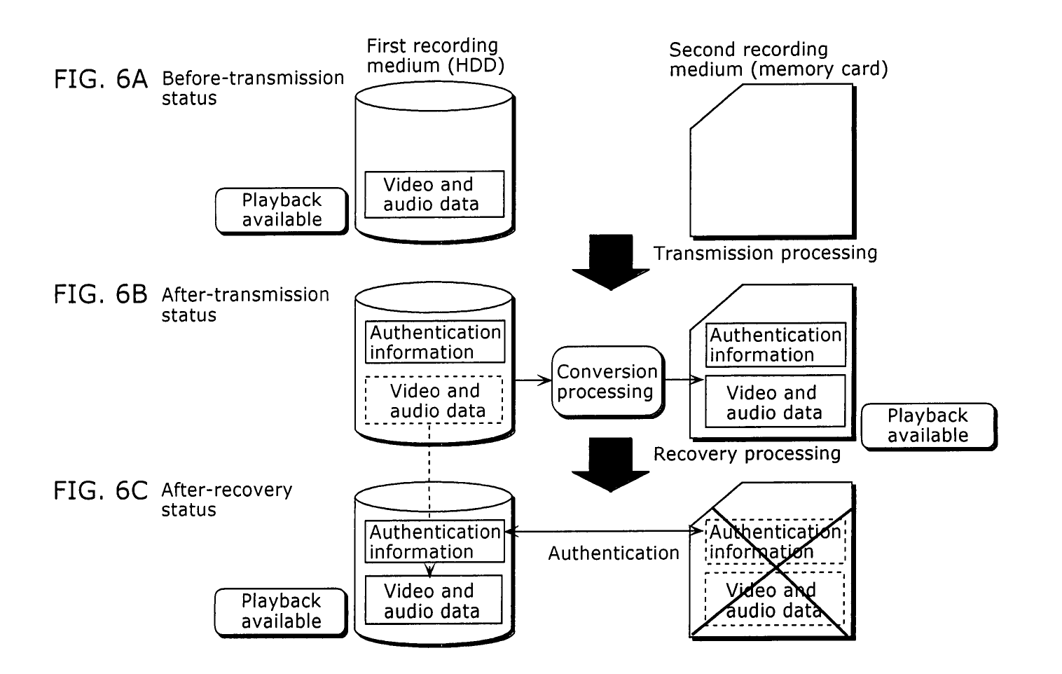

FIGS. 6A to 6C are diagrams conceptualizing the use statuses before and after data is transmitted.

FIG. 6A shows a before-transmission status, FIG. 6B shows an after-transmission status and FIG. 6C shows the status after the data in the second recording medium is viewed and then the data held on the first recording medium is recovered. Also, in the figures, the first recording media (such as HDDs) are shown in the left and the second recording media (such as memory cards) are shown in the right.

FIG. 6B shows the case where the conversion detail judgment unit 101 judges that transmitting the video and audio data resulting in the deterioration in its picture or audio quality of the video and audio data down to a predetermined level or below, and the playback disabling unit 106 disables, in a recoverable manner, the playback of the video and audio data recorded on the first recording medium 105.

As shown in FIGS. 6A and 6B, the original video and audio data recorded on the first recording medium 105 is made unavailable for playback at the same time when the data is transmitted, and consequently only the video and audio data recorded on the second recording medium is made available for playback. In this way, the status where a normal move processing is executed can be realized.

On the other hand, as shown in FIG. 6C, in the case where the data is viewed by means of the second recording medium 110 and the video and audio data transmitted to the second recording medium 110 is deleted, the video and audio data that has made unavailable for playback on the first recording medium 105 can be recovered and become available after the deletion of the copied data is confirmed.

As shown in FIGS. 6A to 6C, since only the data recorded on one of the recording media can be played back in a certain status, the copyright can be protected. Also, a user can always hold and view the original data with no picture deterioration by disabling the playback of the video and audio data recorded on the second recording medium. This enables the user to recover the data held on the first recording medium without re-transmitting the video and audio data transmitted to the second recording medium to the first recording medium. Further in this embodiment, the user can easily realize this status without taking a trouble to perform complex settings of conversion parameters.

As for a method for realizing a recovery system like the one shown in FIG. 6C, the method including the following two steps is available. First, video and audio data recorded on the respective recording media is encrypted based on the unique information of the first recording medium on which the original data is recorded, the unique information of the device to which the first recording medium is belong, and the unique information of the second recording medium that is the data transmission destination. Second, the authentication information shown in FIGS. 6B and 6C is used to enable the alternate authentication of the original data on the first recording medium and the data on the second recording medium. Note that the present invention is not limited to the transmission method that can be exclusively used by means of one of these two recording media. The original data may be recovered as available for playback protecting the copyright according to a predetermined procedure.

As for an encryption method for copyright protection, there is a system conceived for use with a CPRM used for a DVD-RAM or an SD memory card or one of the other recording media. However, the present invention is not limited to this system. In other words, the encryption method used in this invention is not limited to a predetermined system used in this technical field. Further, in the case where encryption key information and encryption processing are additionally required at the time when the data is transmitted between those two recording media so that the data can be exclusively used, such additional processing is executed.

As described up to this point, in the case where the level of deterioration in picture and sound quality generated after the conversion and transmission processing is judged as low or none, it is possible to easily realize a win-win relationship of copyright protection and userfriendliness at the same time. More specifically, copyright is protected by deleting the original data or disabling the playback of the original data in an unrecoverable manner according to a normal move processing resulting in preventing the double storage of the original data and the copy data with an equivalent quality. Also, userfriendliness can be improved by making the most of the capacity of an external recording medium.

Further, here is the case where judgment is that the picture and sound quality has significantly deteriorated. Copyright is protected by maintaining the status where the data can be always exclusively played back by means of a single recording medium. This status can be realized by disabling the playback of the original data in a recoverable manner and by performing exclusive transmission of the data between these two recording media according to a predetermined procedure. In other words, to prevent the status where the original data and the copy data with an equivalent quality are doubly held is to suit with the intention of the owner of the copyright. At the same time, userfriendliness is improved by exclusively allowing a user to view the low quality data recorded on the second recording medium or the high quality original data recorded on the first recording medium at home.

Note that the present invention is not limited to the above-described embodiment. For example, the first recording medium does not have to be included in the video and audio data transmitting apparatus, that is, the first recording medium may be connected to the video and audio data transmitting apparatus with a wire or wirelessly. Further, this is true of the second recording medium. The second recording medium may be included in the video and audio transmitting apparatus at the time when the data is transmitted to the second recording medium. Also, the data may be transmitted to the second recording medium using an external apparatus connected using a wire or the like.

Also, the respective functional blocks shown in FIG. 2 and FIG. 3 are typically realized as an LSI that is an integrated circuit. These blocks may be realized in chips respectively. Also, a part of or all of the functional blocks may be integrated into a single chip.

Also, not only an LSI but also an exclusive circuit or a general processor may be used for realize an integrated circuit. Also, a field programmable gate array (FPGA) that is programmable after such an LSI is made or a reconfigurable processor that can reconfigure the connection or the settings of the circuit cell in the LSI.

Also, among those functional blocks, only the block for storing the data to be coded or decoded may be made into a separate chip instead of being integrated into another chip into which other functional units are integrated.

### Second Embodiment

Next, the second embodiment concerning the present invention will be described with reference to figures. Note that same reference numbers are assigned to the units that have the same operational functions as those of the units in the earlier embodiment.

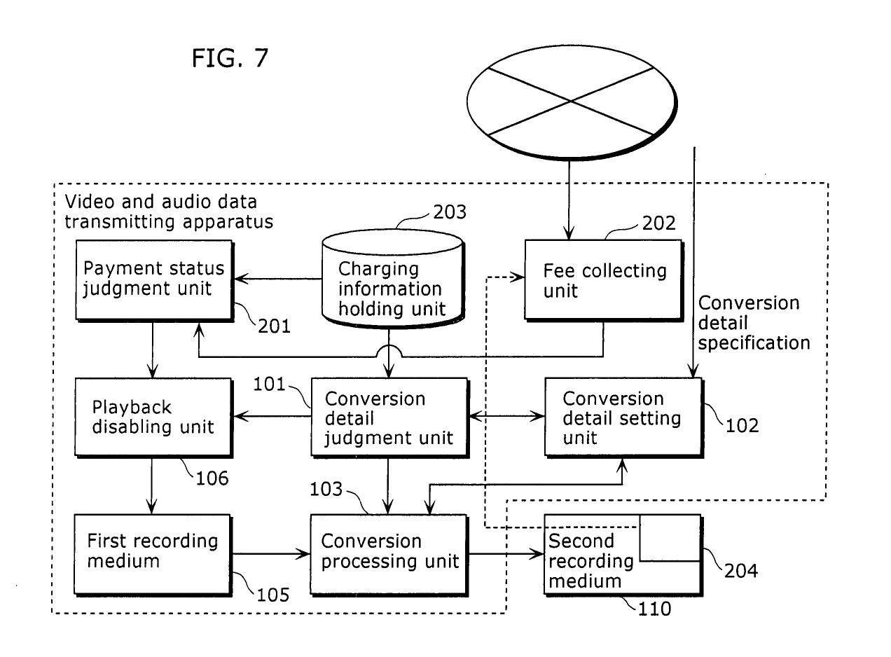

FIG. 7 is a block diagram showing the respective functions of the video and audio data transmitting apparatus concerning this embodiment of the present invention.

Like in the case of the earlier embodiment, the video and audio data transmitting apparatus shown in the figure includes: a first recording medium 105; a second recording medium; a playback disabling unit 106; a conversion detail judgment unit 101; a conversion detail setting unit 102; and a conversion processing unit 103. In addition to these units, the video and audio data transmitting apparatus includes: a payment status judgment unit 201; a fee collecting unit 202; and a charging information holding unit 203.

The playback disabling unit 106 disables, in a completely recoverable manner, the playback of the video and audio data recorded on the first recording medium 105 according to a predetermined condition based on the judgments made by the conversion detail judgment unit 101 and the later-described payment status judgment unit 201 respectively.

Note that this playback disabling unit 106 can disable the playback of the video and audio data in an unrecoverable manner by deleting a part of or all of the video and audio data depending on a combination of judgments made by these two units.

The payment status judgment unit 201 makes a judgment as to one of the following: whether a user has paid the fee according to the conversion details with which the video and audio data has been transmitted or not based on the later-described charging information 203d held in the previously set charging information holding unit 203; and whether the fee collecting unit 202 has collected the fee or not. After that, the payment status judgment unit 201 provides the playback disabling unit 106 with the result.

The fee collecting unit 202 collects a necessary fee at the time when video and audio data is transmitted. The fee collecting unit 202 includes a function for exchanging information of the reception of a necessary fee via the Internet and collecting the fee by means of a prepaid card or the like.

The charging information holding unit 203 is a recording medium such as an HDD for storing the information of charging and a semiconductor memory for temporally holding the charging information 203d obtained via the Internet.

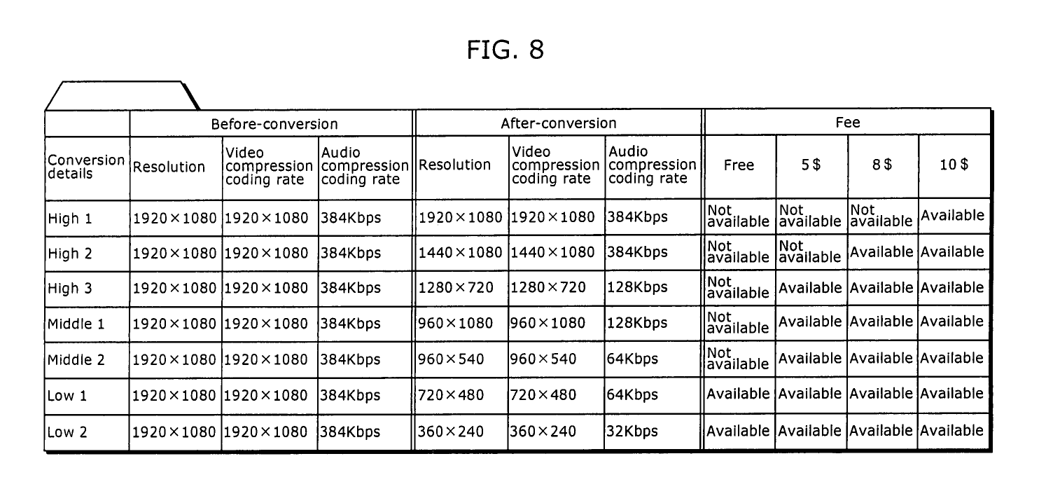

FIG. 8 is a diagram conceptualizing the details of the charging information 203d held in the charging information holding unit 203.

As shown in the figure, the charging information 203d defines possible fees paid at the time when the video and audio data recorded on the first recording medium 105 is transmitted to the second recording medium 110. Such fees vary depending on the conversion details including the following: (i) the deterioration level in resolution and compression coding rates; and (ii) the playback disabling status which determines whether the data is recoverable or unrecoverable later on. Here is an example case where such data is transmitted according to conversion details listed in the line named “High 2”. In the case where no fee is paid, the original data recorded on the first recording medium is made unavailable for playback in an unrecoverable manner. In contrast, in the case where 8 dollars are paid, the data is made unavailable for playback in a recoverable manner. In the latter case, the original data stored on the first recording medium 105 can be recovered in the case where the video and audio data transmitted to the second recording medium is made unavailable for playback in an unrecoverable manner.

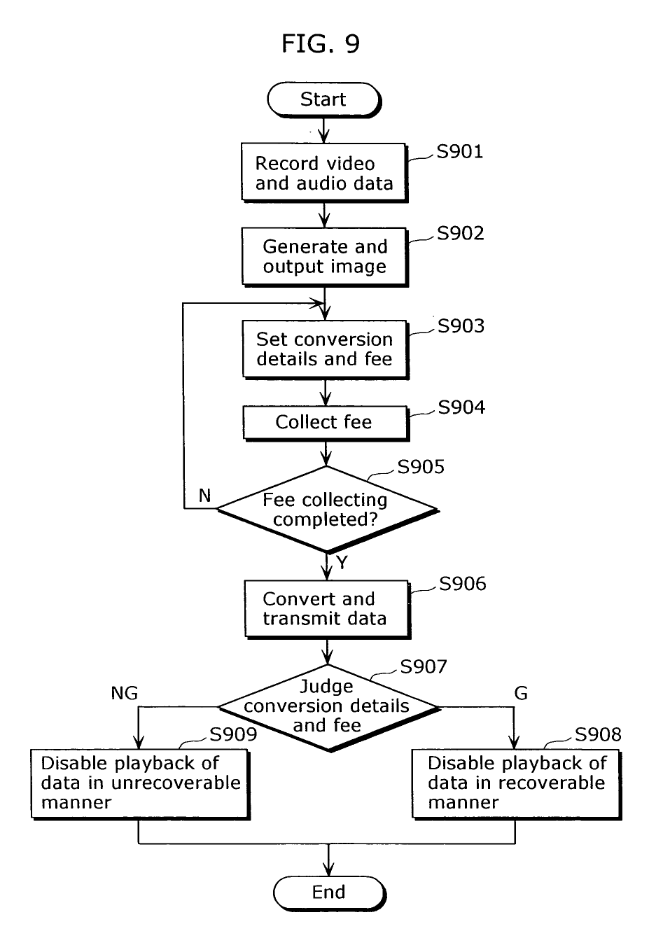

Next, the operation performed in this embodiment will be described with reference to FIG. 9.

FIG. 9 is a flow chart showing the processing operation of the video and audio data transmitting apparatus concerning the second embodiment.

First, like in the case of the earlier embodiment, the video and audio data is received from a known communication mean through a tuner and recorded on the first recording medium 105 (S901).

The copyright of the video and audio data recorded on this first recording medium 105 can be protected because the data is encrypted according to the copy control signal multiplexed with the broadcast data before being recorded.

In this embodiment, like in the case of the earlier embodiment, at the time when the video and audio data with a copy control signal indicating “copy-once” is broadcast, distributed and recorded on the first recording medium 105 such as an HDD, the copy control signal indicating “copy-once” is changed to a copy control signal indicating “copy-no-more” and the “copy-no-more” signal is multiplexed with the video and audio data in the recording process.

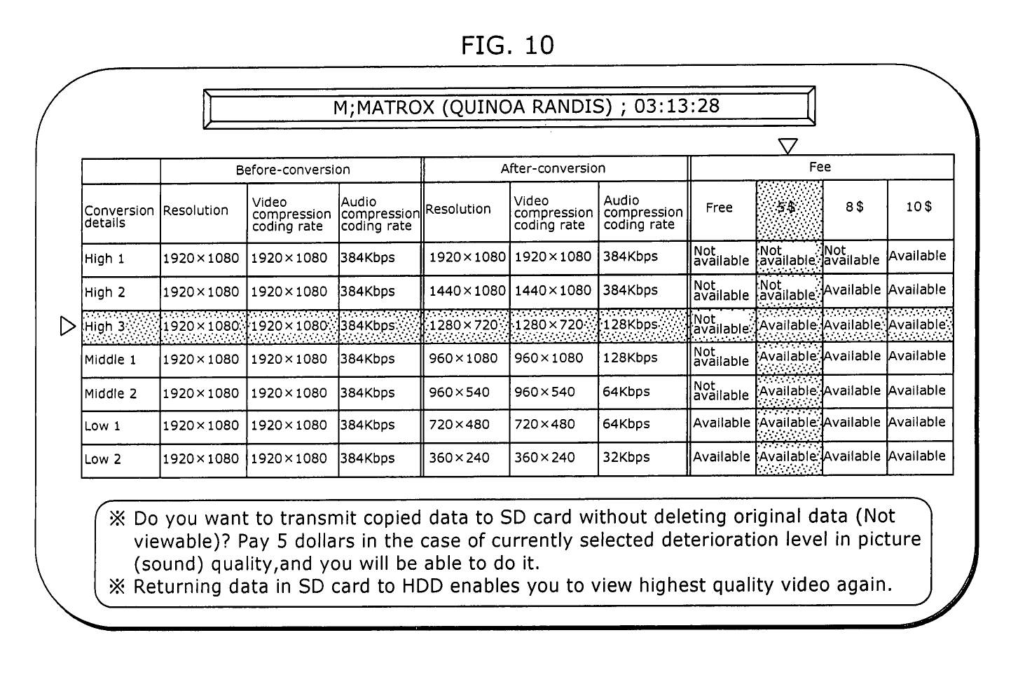

Next, the conversion detail setting unit 102 generates an image shown in FIG. 10 based on the charging information 203d held in the charging information holding unit 203 and output the image (S902).

The user sets conversion details and the due fee by moving the cursor in the display screen (S903).

Next, the fee collecting unit 202 collects the previously set fee (S904). Fee charging method is arbitrary. For example, the video and audio data transmitting apparatus connected to the Internet may charge by means of credit card settlement, payment by Pay Per View (PPV), subtracting a due fee from the balance on a prepaid card, or the like.

In this embodiment, as shown in FIG. 7, a fee information recording unit 204 that-may charge the second recording unit for a fee is installed in the second recording medium, and the fee that has been set by the fee information recording unit 204 is collected.

Next, a payment status judgment unit 201 judges the payment status (collection), and also judges whether the set fee has paid or not (S905). In the case where the balance is not enough to cover the fee to be subtracted (S905:N), the payment status judgment unit 201 instruct a user to reset the fee. In contrast, in the case where the balance is enough to cover the fee to be subtracted (S905:Y), the format of the video and audio data is converted according to the conversion details and then transmitted to the second recording medium 110.

Next, the playback disabling unit 106 judges the paid fee and the transmitted conversion details, and disables the playback of the video and audio data recorded on the first recording medium 105, the playback being disabled in a recoverable manner (S908) or in an unrecoverable manner (S909).

Note that a copy control signal is multiplexed with the video and audio data at the time when the data is transmitted to the second recording medium. In this embodiment, a copy control signal indicating “copy-no-more” is multiplexed with the data so as to prohibit copying of the data held on the second recording medium.

This is the completion of the transmitting processing.

Charging a fee at the time of transmitting the video and audio data in this way allows a user to view the video and audio data with high picture and sound quality recorded on the second recording medium 110 instead of the video and audio data held on the first recording medium 105. Further, the original data on the first recording medium can be completely recovered when the data recorded on the second recording medium 110 becomes unnecessary.

On the other hand, the provider of the copyrighted video and audio data can protect the copyright effectively because he can secure a profit by collecting a fee even in the case where the data in the following states coexist: the data made to be unavailable for playback in a recoverable manner; and the available (viewable) data.

Note that the video and audio data transmitting apparatus may have the following additional function.

More specifically, the additional function is for refunding a part of or all of these fees collected at the time when transmitted from the first recording medium 105 in the case where the video and audio data transmitted to the second recording medium 110 is made unavailable for playback in an unrecoverable manner.

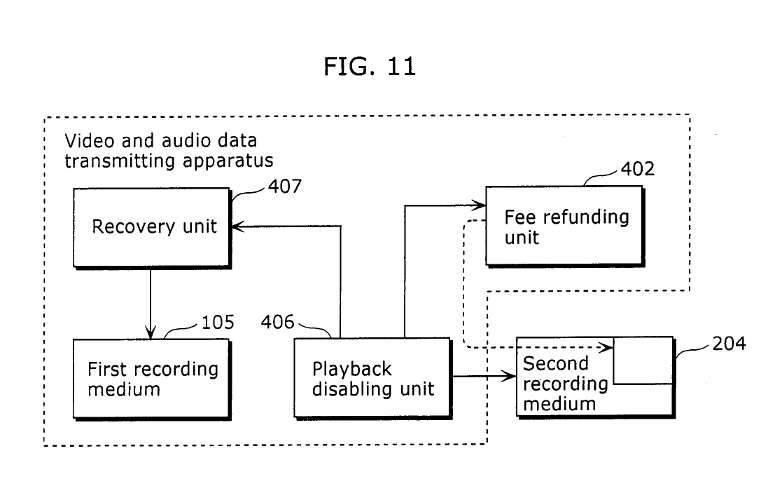

FIG. 11 is a block diagram showing the additional functions of the video and audio data transmitting apparatus.

As additional functional units, the video and audio data transmitting apparatus includes: a playback disabling unit 406 for disabling, in an unrecoverable manner, the video and audio data recorded on the second recording medium 110; a recovery unit 407 for recovering the video and audio data held on the first recording medium 105 that has been made unavailable for playback in a recoverable manner; and a fee refunding unit 402 for refunding a part of or all of the fee that has been collected in the case where the video and audio data recorded on the second recording medium 110 is made unavailable for playback in an unrecoverable manner.

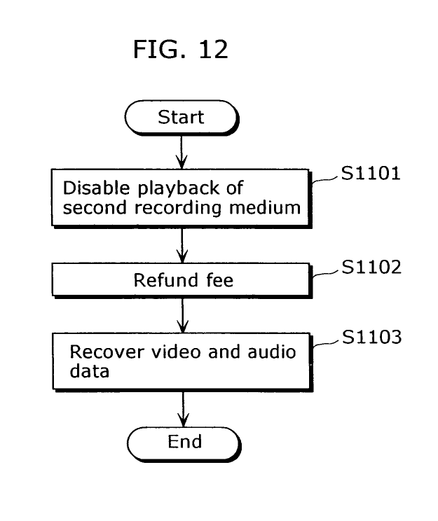

FIG. 12 is a flow chart showing the processing status of the additional functions.

First, the playback disabling unit 406 disables, in an unrecoverable manner, the playback of the video and audio data recorded on the second recording medium 110 (S1101).

The fee refunding unit 402 refunds a part of the fee according to a predetermined term or the term during which the data has been held in a recoverable manner on the second recording medium 110 when the playback of the video and audio data on the second recording medium has been disabled (S1102).

Next, the recovery unit 407 recovers the video and audio data that is made unavailable for playback in a recoverable manner on the first recording medium 105 (S1103).

Refunding a part of the paid fee at the time of performing recovery processing in this way prompt a user to transmit the video and audio data to the second recording medium and view the high quality data, and thus userfriendliness is further improved. In contrast, the owner of the copyright can prevent the user from randomly transmitting the data by employing a deposit system.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The video and audio data transmitting apparatus and the video and audio data transmitting method in the present invention are useful for (i) transmitting, to a second recording medium, copyrighted digital video and audio data that has been received through digital television broadcasting and recorded on a first recording medium and (ii) causing another playback apparatus to play back the video and audio data and to accumulate such data.

What is claimed is:

1. A video and audio data transmitting apparatus that transmits video and audio data recorded on a first recording medium to a second recording medium, said apparatus comprising:
a conversion processing unit operable to convert a format of video and audio data recorded on a first recording medium;
a conversion detail judgment unit operable to judge details of the conversion which is performed by said conversion processing unit; and
a playback disabling unit operable to disable, in a recoverable manner, playback of the video and audio data recorded on the first recording medium based on the judgment made by said conversion detail judgment unit.

2. The video and audio data transmitting apparatus according to claim 1, said apparatus further comprising
a completion signal notification unit operable to output a conversion completion signal to said playback disabling unit at the time when said conversion processing unit completes conversion processing,
wherein said playback disabling unit is operable to perform disabling processing after receiving the conversion completion signal.

3. The video and audio data transmitting apparatus according to claim 1,
wherein said conversion processing unit includes:
a video and audio demultiplexing unit operable to demultiplex the multiplexed video and audio data; and
a video and audio multiplexing unit operable to multiplex the demultiplexed video data with the demultiplexed audio data and operable to output the resulting multiplexed video and audio data, and
at least the demultiplexed one of video data and audio data is converted.

4. The video and audio data transmitting apparatus according to claim 3,
wherein said conversion processing unit further includes:
a video decoding unit operable to decode the demultiplexed video data;
a resolution conversion unit operable to convert a resolution of the video data decoded by said video decoding unit; and
a video coding unit operable to code the video data with a converted resolution.

5. The video and audio data transmitting apparatus according to claim 3,
wherein said conversion processing unit further includes:
an audio decoding unit operable to decode the demultiplexed audio data;
an audio sampling rate conversion unit operable to convert at least one of the following of the audio data decoded by said audio decoding unit: a sampling frequency; and the number of sampling bits; and
an audio coding unit operable to code the audio data with a converted audio sampling rate.

6. The video and audio data transmitting apparatus according to claim 3,
wherein said conversion processing unit further includes
a frame rate conversion unit operable to convert a frame rate of the video data.

7. The video and audio data transmitting apparatus according to claim 1, said apparatus further comprising
a payment status judgment unit operable to judge a fee payment status, the fee being charged for data transmission,
wherein said playback disabling unit is operable to disable, in a recoverable manner, playback of the video and audio data recorded on the first recording medium based on a combination of the following two judgments: the judgment made by said payment status judgment unit and the judgment made by said conversion detail judgment unit.

8. The video and audio data transmitting apparatus according to claim 7,
wherein the second recording medium includes
a fee information recording unit on which information concerning payment of a fee is recorded, and
said video and audio data transmitting apparatus further comprises
a fee collecting unit operable to collect a fee from said fee information recording unit.

9. The video and audio data transmitting apparatus according to claim 7, said apparatus further comprising
a fee refunding unit operable to refund a fee in the case where video and audio data transmitted to a second recording medium is made unavailable for playback in an unrecoverable manner.

10. A video and audio data transmitting method for transmitting video and audio data recorded on a first recording medium to a second recording medium, said method comprising:
converting of a format of video and audio data recorded on a first recording medium;
judging of conversion details of the video and audio data; and
disabling, in a recoverable manner, of playback of the video and audio data recorded on the first recording medium based on the judgment made in said judging of the conversion details.

11. A video and audio data transmitting program for processing video and audio data recorded on a first recording medium at the time when the video and audio data recorded on the first recording medium is transmitted to a second recording medium, said program causing a computer to execute a video and audio data transmitting method that includes:
converting of a format of video and audio data recorded on a first recording medium;
judging of conversion details of the video and audio data; and
disabling, in a recoverable manner, of playback of the video and audio data recorded on the first recording medium based on the judgment made in said judging of the conversion details.

12. A semiconductor integrated circuit that transmits video and audio data recorded on a first recording medium to a second recording medium, said circuit comprising:
a conversion processing circuit that converts a format of video and audio data recorded on a first recording media;
a conversion detail judgment circuit that judges details of conversion which is performed by said conversion processing circuit; and
a playback disabling circuit that disables, in a recoverable manner, playback of the video and audio data recorded on the first recording medium based on the judgment made by said conversion detail judgment circuit.
